(19) United States
(12) Patent Application Publication
(10) Pub. No.: US 2008/0018540 A1
(43) Pub. Date: Jan. 24, 2008

(54) Portable antenna device

(76) Inventor: Chih-Yuan Hsueh, Tauyuan Hsien (TW)

Correspondence Address: Hsueh, Chih-Yuan, 20525 Via Talavera, Yorba Linda, CA, 92887, US

(21) Appl. No.: 11/491,509

(22) Filed: Jul. 24, 2006

(51) Int. Cl. H01Q 1/24

(52) U.S. Cl. 343/702

(57) ABSTRACT

The present invention provides a portable antenna device comprising of an antenna, a digital box, a signal wire and a storage container. The antenna receives an analog signal and the digital box transfers the analog signal received from the antenna into a digital signal and transmits the digital signal to an electronic device. The signal wire transmits the analog signal received from the antenna to the digital box; and the storage container stores the digital box and the signal wire, wherein the antenna is located firmly within the storing container. The portable antenna device of the present invention can easily be carried around and be stored easily in a storage case with a modern designed appearance.

### BACKGROUND OF THE INVENTION

1. Field of Invention

The present invention relates to a portable antenna device, particularly, the present invention relates to a portable antenna device that comprises of a digital device, an antenna and a signal wire.

2. Description of the Related Art

FIG. 1 is a schematic 3-D view of a conventional antenna utilized on a laptop. The conventional antenna device comprises of a signal connector 31 of a signal antenna 3 inserted into a signal-receiving hole 21 of a digital box 2. The Universal Serial Bus (USB) 22 of the digital box 2 is electrically connected to the USB 41 of an electronic apparatus 4, such as a laptop, so that the conventional antenna can receive an analog signal. The analog signal is then transmitted from an output 11 of the conventional antenna 1, through an end of the signal connector 31 installed in the signal wire 3. The signal wire 3, the signal connector 31, and the signal-receiving hole 21 reaches to the digital box 2. The digital box 2 then transfers the analog signal into a digital signal and sends the digital signal through the USB 22 of the digital box 2 and the USB 41 of the electronic apparatus 4 in order to reach the electronic apparatus 4.

A conventional antenna device can transfer the analog signal into the digital signal and output to the electronic apparatus. The conventional antenna device still consists of several disadvantages that cannot fulfil the demands of high efficiency in modem lifestyle, such that its designed structure cannot be transported easily..

Present day societies increasingly have to rely on electronic apparatuses such as computes, laptops and other comparable portable electronic in everyday life. With the increasing demands of portable electronic apparatuses, various techniques have been developed to increase the utilization of antenna devices for receiving broadcasts and television signals. Advanced technologies have been developed for wireless communications, particularly, in electronic apparatuses ability in receiving wireless signals.

A conventional antenna is not convenient to carry around, and its size is not compact. Furthermore, the designed appearance of the conventional antenna is not appealing either. Therefore, the objectives of the present invention are to provide a portable antenna device that can easily be carried around or can be stored easily in a storage case with a modem designed appearance.

### SUMMARY OF THE INVENTION

It is an object of the present invention to provide a more compact, reliable and portable antenna device. The portable antenna device of the present invention comprises of an antenna, a digital box, a signal wire and a storage container. The antenna receives an analog signal and the digital box transfers the analog signal received from the antenna into a digital signal and transmits the digital signal to an electronic device. The signal wire transmits the analog signal received from the antenna to the digital box; and the storage container stores the digital box and the signal wire, wherein the antenna is located firmly within the storage container. The portable antenna device of the present invention can easily be carried around and be stored easily in a storage case with a modern designed appearance.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention\together with the description and serve to explain the principles of the invention. In the drawings,

FIG. 1 shows a 3-D schematic view of a conventional antenna device utilized in an electronic apparatus;

FIG. 2 shows a 3-D assembly view of a portable antenna device folding up in accordance with a preferred example of the present invention;

FIG. 3 shows a 3-D view of the portable antenna device stored in a storage case in accordance with a preferred example of the present invention;

FIG. 4 shows a schematic view of the portable antenna device stored within the storage case in accordance with the preferred example of the present invention;

FIG. 5 is a cross-sectional view taken along the cutting lines A-A′ of FIG. 4;

FIG. 6 is a 3-D view of the portable antenna device integrated with an electronic device in accordance with a preferred example of the present invention;

FIG. 7 is a 3-D assembled view of the portable antenna device in accordance with another preferred example of the present invention.

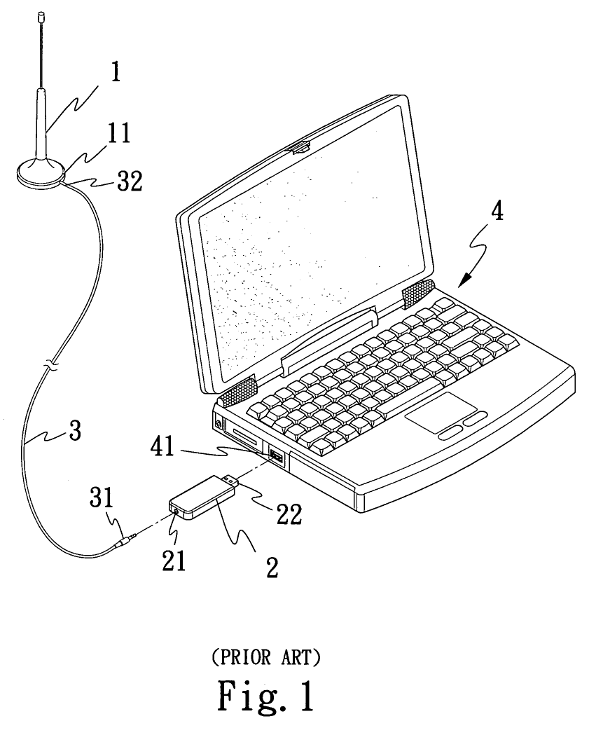

### DESCRIPTION OF THE PREFERRED EMBODIMENTS

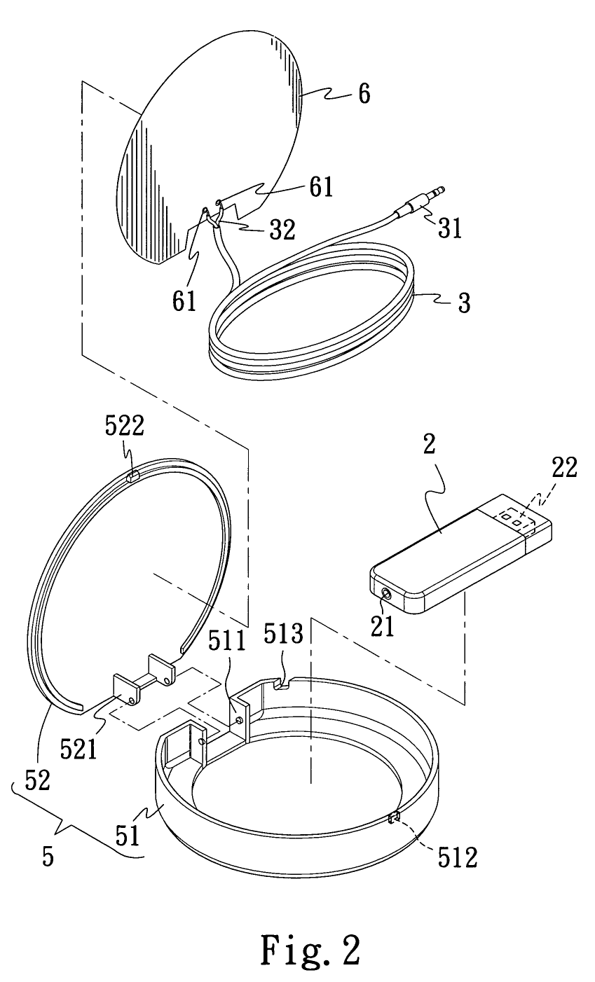

FIG. 2 shows a 3-D schematic view of a portable antenna device in accordance with a preferred example of the preset invention. The portable antenna device of the present invention comprises a digital box 2, an antenna and a signal wire 3. A signal-receiving hole 21 is provided at the digital box 2 to receive analog signals and a USB 22 also is provided in the digital box 2 to transmit the digital signal to an electronic device. The antenna of the portable device is a printed planar antenna 6 that comprises of a printed planar antenna output 61 at one side of the printed planar antenna. A signal connector 31 is provided at one end of the signal wire 3 and is electrically connected to the signal-receiving hole 21 of the digital box 2. Another signal connector, signal wire 32 having a signal wire is electrically connected to the printed planar antenna output 61.

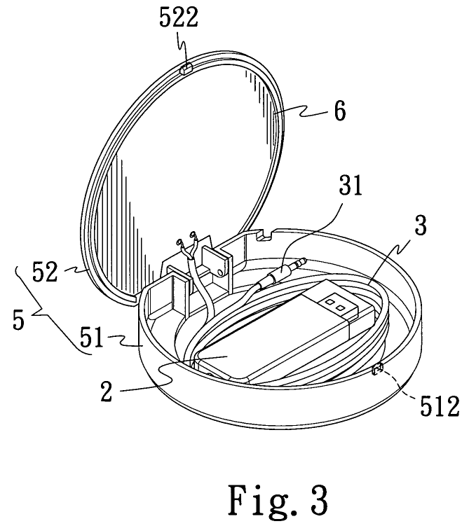

Refer to FIG. 2, the portable antenna device also comprises a storage case such as, a container 5 having a base 51 and a cover 52, wherein the designed structure of the cover 52 is corresponding to the printed planar antenna 6 such that the printed planar antenna 6 can be installed onto the cover 52 of the container 5. FIGS. 2 and 3 illustrate that the printed planar antenna 6 is integrated onto an inner side of the cover 52 that is facing toward the base 51. The cover 52 is assembled to the base 51 through rotating units 521 of the cover 52 integrated with fixed units 511 of the base 51. A male fastener 522 is provided at the cover 52 for locking the cover 52 firmly onto the base 51 via a female fastener 512 of the base 51. A fixing trench 513 is located on the edge of the base 51 to position the signal wire 3 when the portable device is in use.

FIG. 3 shows the portable antenna device stored in a storage case in accordance with a preferred example of the present invention. The printed planar antenna 6 is installed onto the inner side of the cover 52 and the signal wire 3 and the digital box 2 are stored within the base 51 of the container 5.

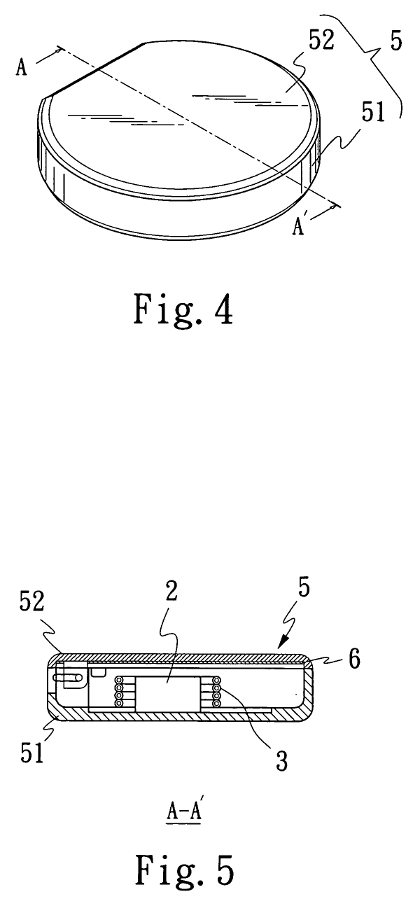

FIG. 4 is a schematic view of the portable antenna device stored within the storage case in accordance with the preferred example of the present invention. Once the printed planar antenna 6, the signal wire 3 and the digital box 2 are stored in the container 5, the male fastener 522 and the female fastener 512 are locked together to form a closed space within the container 5.

FIG. 5 shows a cross-sectional view taken along the cutting lines A-A′ of FIG. 4. The closed space of the container 5 is utilized for storing the printed planar antenna 6, the signal wire 3 and the digital box 2.

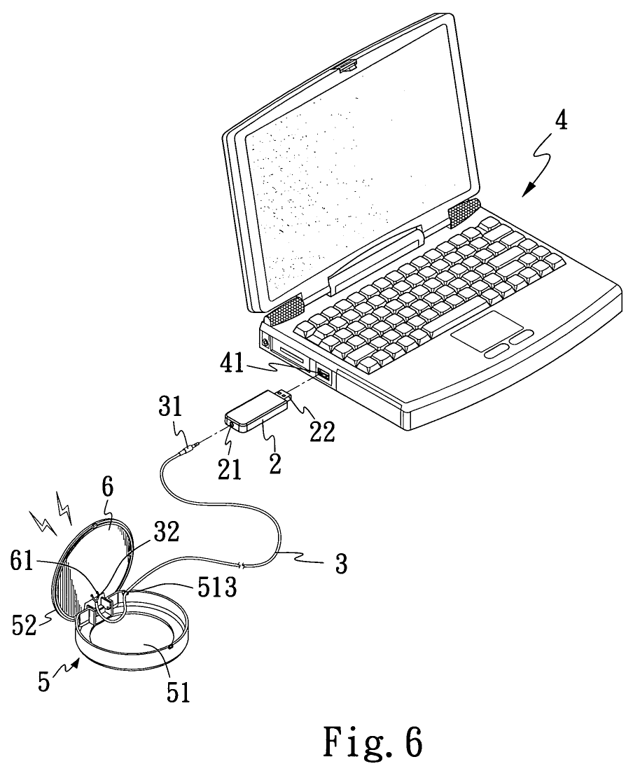

FIG. 6 illustrates a 3-D view of the portable antenna device integrated with an electronic device in accordance with a preferred example of the present invention. When the portable antenna device of the present invention is opened, the cover 52 of the container 5 can be opened approximately 90 degrees in respect to the base 51. The signal wire 3 is stored within the container 5 and the fixing trench 513 is utilized to position the wire portion of the signal wire 3 stationary.

The signal connector 31 of the signal wire 3 is connected to the signal receiving hole 21 of the digital box 2, and the USB 22 of the digital box 2 is electrically connected to a USB 41 of an electronic device 4. The electronic device 4 can be any kind of electronic devices such as, a computer or a laptop. The printed planar antenna 6 is utilized to receive analog signal and the analog signal is transmitted out through the printed planar antenna output 61, the signal connector having signal wire 32, the signal wire 3, the signal connector 31, the signal receiving hole 21 and to the digital box 2. Once the analog signal reaches to the digital box 2, the digital box 2 transfers the analog signal into digital signal and transmits the digital signal through the USB 22 of the digital box 2 to the USB 41 of the electronic device 4 so that the digital signal can reach to the electronic device 4.

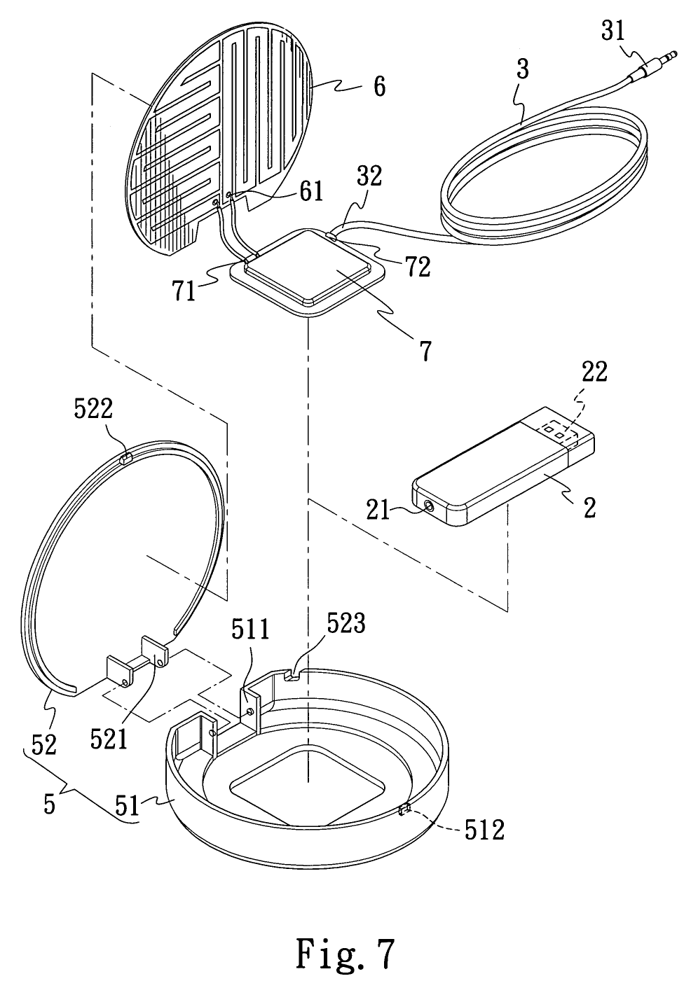

FIG. 7 shows a 3-D assembled view of the portable antenna device in accordance with another preferred example of the present invention. A signal amplifier 7 is used in this example. The printed planar antenna output 61 of the printed planar antenna 6 is electrically connected to a signal input 71 of the signal amplifier 7. A signal output 72 is electrically connected to the signal connector having signal wire 32 of the signal wire 3 so that the analog signal can be transmitted out through the signal amplifier 7 in order to increase the intensity of the signal and the quality of signal output can be improved.

The portable antenna device of the present invention provides an improved antenna that consists of an improved design and it resolves the problem and default of the conventional antenna. The portable antenna device of the present invention can be easily be carried around or can be stored easily in a storage case with a modem designed appearance.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A portable antenna device, comprising an antenna, receiving analog signal;
a digital box, transferring the analog signal received from the antenna into a digital signal and transmitting the digital signal to an electronic device;
a signal wire, transmitting the analog signal received from the antenna to the digital box; and
a storage container, storing the digital box and the signal wire, wherein the antenna is located firmly within the storage container.

2. The portable antenna device of claim 1, wherein the storage container further comprises a cover and a base.

3. The portable antenna device of claim 2, wherein the cover and the based are integrated through rotating units and fixed units.

4. The portable antenna device of claim 1, wherein the digital box further comprises a signal receiving hole integrated with the signal wire to transmit the analog signal from the antenna to the digital box.

5. The portable antenna device of claim 1, wherein the digital box comprises an electronic unit that can transfer the received analog signal into the digital signal and transmit to the electronic device.

6. The portable antenna device of claim 1, wherein the digital box comprises a universal serial bus (USB) for transmitting the digital signal to the electronic device.

7. The portable antenna device of claim 1, wherein the signal wire can be made from copper or aluminium, a signal connector is provided at one end of the signal wire and is electrically connected to the signal receiving hole.

8. The portable antenna of claim 1, wherein the antenna can be a printed planar antenna that is installed on an inner side of the cover of the storing container.

9. The portable antenna of claim 1, wherein a signal connector having signal wire is electrically connected to the antenna to transmit the analog signal to the digital box.

10. The portable antenna device of claim, wherein the portable antenna device further comprises a signal amplifier, an output and an input of the signal amplifier are electrically connected respectively to the signal connector having signal wire in order to transmit the analog signal from the amplifier to the digital box.
